(19) United States
(12) Patent Application Publication
(10) Pub. No.: US 2025/0342253 A1
(43) Pub. Date: Nov. 6, 2025

(54) FORENSIC INVESTIGATION OF PRIVATE CLUSTERS AND DISTROLESS CONTAINERS

(71) Applicant: Cado Security Ltd, Cheshire (GB)

(72) Inventors: Christoper Doman, Cheshire (GB); Paul Scott, Cheshire (GB); John Lugton, Cheshire (GB); Joshua Thompson-Lindley, Cheshire (GB); Aiden Huynh, Cheshire (GB)

(21) Appl. No.: 19/195,299

(22) Filed: Apr. 30, 2025

Related U.S. Application Data
(60) Provisional application No. 63/641,209, filed on May 1, 2024.

(51) Int. Cl. G06F 21/56; G06F 21/54; G06F 21/55

(52) U.S. Cl. CPC G06F 21/566; G06F 21/54; G06F 21/552

(57) ABSTRACT

A security engine can access a container platform through an API to send commands into the container platform to support accessing and copying data from a Target container. The security engine implements methods to conduct an investigation that accesses and copies the data from the target container running in the container platform in with commands and/or steps that satisfy a container platform's policies and a container platform architecture's limitations or settings, in order to access and copy the data from the target container. The security engine can analyze the data from the target container as a part of the investigation to detect for a violation of a policy and malicious activity, associated with the target container. The security engine can suggest remediation actions based upon the analyzed data from the target container and convey the analyzed data in at least one of on a display device and in a report.

### CLAIM FOR PRIORITY

This application claims the benefit under 35 USC 119 of provisional Application Ser. No. 63/641,209 filed on May 1, 2024, which is hereby expressly Incorporated by reference in its entirety for all purposes.

### TECHNICAL FIELD

The present disclosure relates to forensic analysis of computer systems. More particularly, it relates to using a scalable, cloud-based computer architecture for performing forensic analysis of computer systems.

### BACKGROUND

As containerized applications become more prevalent, the security of containers is supreme. Kubernetes, as a leading container orchestration platform, has to address various security concerns. Kubernetes allows the configuration of security contexts for pods and containers, which define example features such as privilege and access control settings, including discretionary access control, SELinux, Linux capabilities, AppArmor, and seccomp. Ensuring the security of the complete pipeline, from build to deployment, is monumental. This includes securing the build environment, registry, and the application workloads running in Kubernetes.

Container security has to be integrated and continuous, supporting the overall security posture of an enterprise. Kubernetes offers rich contextual data for better visibility, compliance, context-based risk profiling, networking, and runtime detection.

Private clusters and distroless containers are technologies with mature security (and often regulated) customers, for example, large financial and healthcare institutions.

### SUMMARY

An aspect of the present disclosure provides a security engine to access a container platform through an API to send commands into the container platform to support accessing and copying data from a target container. The security engine implements methods to conduct a forensic investigation that accesses and copies the data from the target container running in the container platform in with commands and/or steps that satisfy a container platform's policies and a container platform architecture's limitations or settings, in order to access and copy the data from the target container. The security engine can analyze the data from the target container as a part of the forensic investigation to detect for a violation of a policy and/or malicious activity associated with the target container. The security engine can suggest remediation actions based upon the analyzed data from the target container and convey the analyzed data in at least one of on a display device and in a report.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the example figures:

FIG. 1 illustrates a block diagram of an embodiment of a security engine configured to run on a back-end server of a cloud platform to dynamically provide an electronic and digital forensic investigation to access data from a containerized environment;

FIG. 2 illustrates a diagram of an embodiment of a user interface that directs a security host to create and download a version of a security host binary executable application based upon a category of operating system utilized by a computing system supporting the container platform with the target container;

FIG. 3 illustrates a diagram of an embodiment of a user interface that allows a user to create a sidecar container that shares a same namespace and resource space with the target container;

FIG. 4 illustrates a diagram of a user interface that allows a user to generate commands and download a version of a security host binary executable application;

FIG. 5 illustrates a flowchart of an example electronic and digital investigation of the target container by the security engine;

FIG. 6 illustrates a block diagram of an embodiment of the security host binary executable application getting information from the target container and the files gathered;

FIG. 7 illustrates a block diagram of an embodiment of the security engine creating an ephemeral sidecar container to link with the target container so that the ephemeral debug container can host the security host binary executable application to collect the information and files from the target distroless container sharing a pod, in order to provide a mechanism to obtain the information in these containers and then send that information over to the storage bucket; and

FIG. 8 illustrates a block diagram of an embodiment of one or more computing devices that can be a part of the security engine and other components discussed herein.

In the Figures, similar components and/or features may have the same or similar reference label. When the same reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

In general, a network can include one or more on-premises networks and a cloud network containing one or more containerized systems running on one or more servers with files or other data stored on one or more databases associated with the cloud network. A container in a Kubernetes or similar containerized environment sits upon and operates on top of middleware software and then ultimately on one or more servers working with one or more databases. The container(s) run in the Application Layer, which typically includes application code, runtime (e.g., Node.js, Python, Java), dependencies (libraries, packages), and configuration. The container is orchestrated by Kubernetes (or a similar system), allowing it to be scheduled on a node, managed for scaling, health, updates, and/or isolated from other containers. A containerized app handles the business logic or task it has been configured to do. Next, the middleware acts as a service layer. The container often interacts with middleware software, such as Web servers (e.g., Nginx, Apache); message brokers (e.g., Kafka, RabbitMQ); API gateways; authentication services; and service meshes (like Istio or Linkerd). Middleware acts as a bridge between the application and the infrastructure. Middleware provides services like request routing; load balancing; logging and metrics; and communication with databases or other services. The container sends/receives data via middleware (like a message queue or API gateway). Next, the server infrastructure can act as a node layer. The container and middleware ultimately run on a host machine, which could be Virtual Machines (VMs); Bare-metal servers; and/or Cloud instances. In Kubernetes, these could include worker nodes as part of a cluster, and the Kubernetes control plane schedules containers (pods) on these nodes. All of the above layers run on underlying servers (e.g. nodes) managed by, for example, Kubernetes. Next, the database infrastructure can act as a data layer. The database is accessed via services exposed by the middleware or app logic. The data is stored/retrieved from databases.

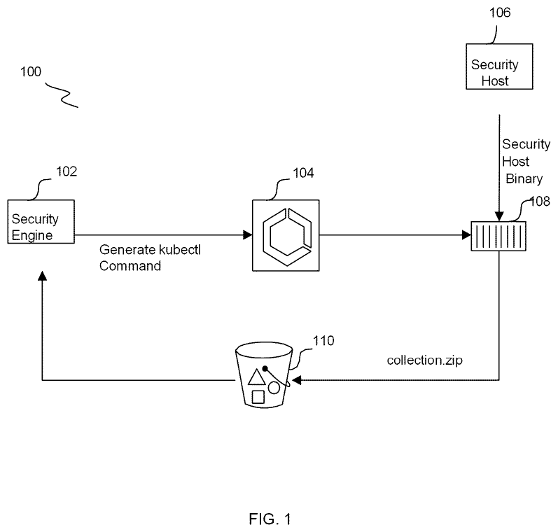

FIG. 1 illustrates a block diagram of an embodiment of a security engine configured to run on a back-end server to dynamically provide an electronic and digital forensic investigation to access data from a containerized environment. Referring to FIG. 1, the forensic investigation system can include a security engine 102, a container/cluster access platform 104, a sidecar container 108, a security host 106, and a cloud storage location 110 such as a private bucket and/or web server. The security engine 102 can dynamically provide the electronic and digital forensic investigation to access data from, for example, a containerized environment with two or more different methods to adapt to the particular needs of the containerized environment being accessed. The security engine 102 and the security host 106 cooperate to conduct the electronic and digital forensic investigation to access data from a component, such as a target container, which is very historically hard to collect data on. The security engine 102 and/or a security host binary executable application can then copy forensic data, such as a full disk image or specific container level data/information, from that target container in a Kubernetes or similar containerized environment. The target container can be ephemeral in nature. The security engine 102 and/or a security host binary executable application are robust to the ephemeral nature of these environments as well as the diversity found in the containerized environments. The security engine 102 and/or a security host binary executable application are robust to the complications of networking and other access limitations in potentially managed environments as well as non-Internet exposed environments (e.g., private clusters). The security engine 102 and the security host binary executable application cooperate to support a way to copy data back to the security engine 102 for analysis.

First, the security engine 102 can access a third party container platform through a bastion host 104 or other containerized environment access mechanism via an Application Programming Interface to send one or more commands into the third party container platform, (e.g., AWS) to support accessing and copying data from a target container. For example, the security engine 102 can generate a kubectl command to the Kubernetes API. Kubernetes provides a command line tool, kubectl, for communicating with a Kubernetes cluster's control plane using the Kubernetes API. The command is running through the containerized environment access mechanism 104, a system with access to the Kubernetes cluster's control plane. The containerized environment access mechanism 104 can be a Bastion Host, a systems manager (SSM), an Amazon Web Services (AWS) Private link, an AWS Cloud9, an AWS virtual private network (VPN), and an AWS Direct Connect. The security engine 102 can access the Kubernetes cluster's control plane API for normal data acquisition methods, acquiring the container's details via the user interface to create a valid route at the network level from the security engine 102 to the Kubernetes API. When direct contact between the security engine 102 and Kubernetes API is not possible, such as when dealing sometimes with private clusters, the security engine 102 can use other methods to conduct the investigation. Note, that the private cluster of nodes utilizes internal IP addresses for all components, including the control plane and worker nodes, and any containers, which means the private cluster of nodes is isolated from the public internet by default, enhancing security and allowing for more control over network traffic. Private clusters can be deployed within a Virtual Private Cloud (VPC) network, and their components communicate solely through internal IP addresses within that VPC. The private clusters can be a configuration within a Kubernetes environment where the nodes (e.g., worker machines) do not have external IP addresses. This means that the users on the public Internet cannot directly connect to the IP addresses of these nodes. Private clusters are particularly useful for workloads that entail controlled access due to data privacy and security regulations. However, the security engine 102 uses the methods discussed herein to access a cloud container with a private cluster of nodes.

The security engine 102 can execute a script differently depending upon the environment. For example, Amazon ECS containers can use ECS execute, while EKS, AKS, and GKE can use the Kubernetes control plane API. The security engine 102 can authenticate with the Kubernetes API and use IAM permissions.

Next, the security engine 102 can also invoke a security host that is hosted on one or more URLs. The security host can create and download a version of a security host binary executable application based upon a category of operating system utilized by a computing system supporting the container platform with the target container. The security host binary executable application can run in a container, within or alongside the target container depending upon the type of target container being monitored and analyzed, and will work with the target container in order to access and copy the data from the target container in a form and format that preserves a forensic nature of the copied data to maintain a full chain of custody for a forensic investigation. Once the security host 106 is invoked, the security host 106 can create a security host binary executable application. The security engine 102 cooperating with the security host 106 can create and deploy the security host binary executable application to identify relevant data from a target container that is accessible from an ephemeral side-car container (e.g., debug container) under, for example, the folder “/proc/1.” The security host 106 can be configured to identify how to attach a side-car container without root access being available within a container using the “sysadmin” profile.

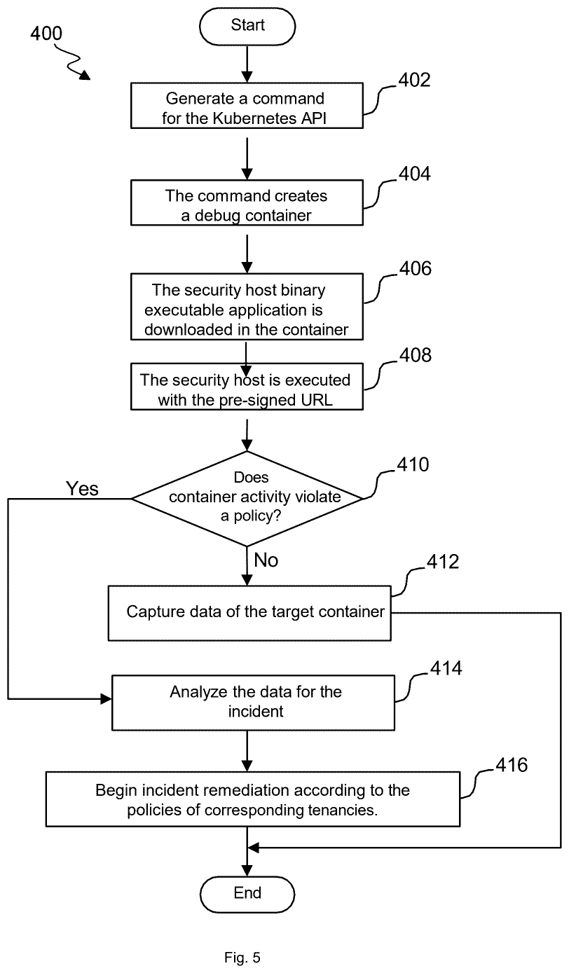

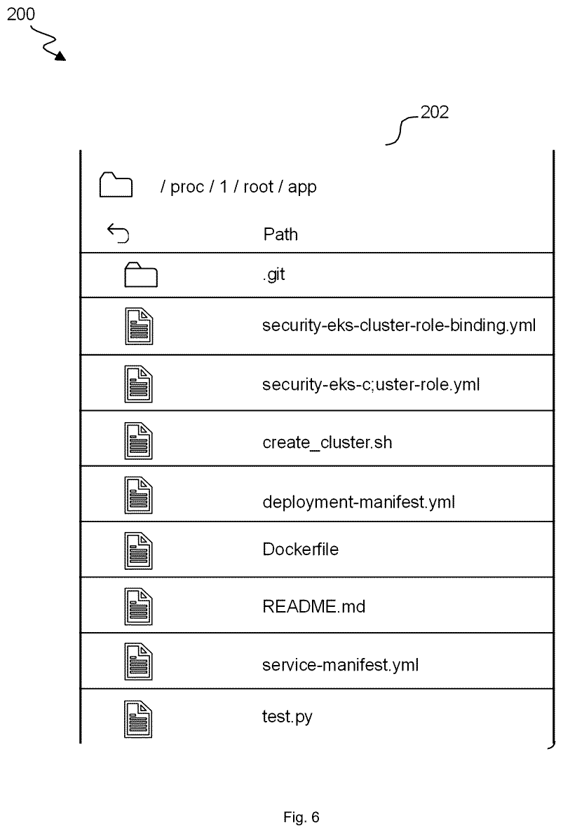

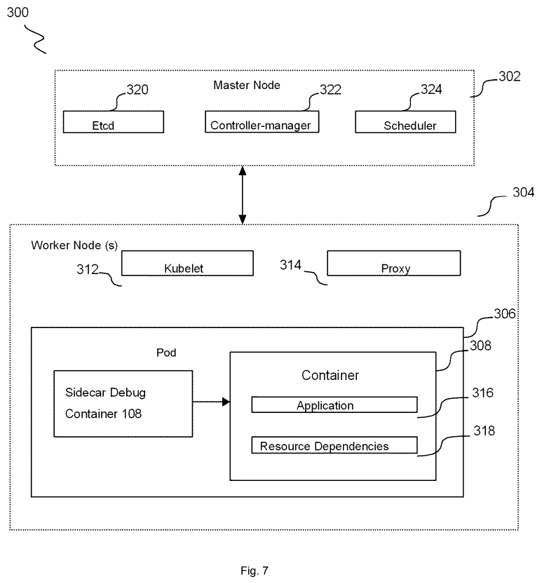

Next, the security engine 102 can utilize one or more methods to conduct an investigation that accesses and copies the data from the target container running in the third party container platform in with commands and/or steps that satisfy 1) a third party container platform's policies and 2) a third party container platform architecture's limitations or settings, in order to access and copy the data from the target container. 1) In a first method to conduct an investigation, the security engine 102 can access the third party container platform and create a full disk image that includes the target container. The security engine 102 uses commands and/or steps that satisfy 1) the third party container platform's policies and 2) the third party container platform architecture's limitations or settings, in order to access and copy the data from the target container. The full disk image can include content from the underlining server and database supporting that containerized platform, along with the target container. 2) In second method conduct an investigation, when a third-party container provider's policies and/or architecture do not allow the security engine 102 to make a full disc image of the target container through commands on the API for the containerized platform, then the security engine 102 can invoke a security host to create and send down a security host binary executable application to run in a container, alongside or within the target container depending upon the type of target container being monitored and analyzed, and will work with the target container with commands and/or steps that satisfy 1) the third party container platform's policies and 2) the third party container platform architecture's limitations or settings, in order to access and copy the data from the target container. (See for example FIGS. 5 and 7) The security engine can use the second method to run the security host binary executable application i) within the target container or ii) create a sidecar container to link with the target container in a same pod as the target container, with commands and/or steps create the sidecar container or download with the target container in order to satisfy 1) the third party container platform's policies and 2) the third party container platform architecture's limitations or settings, in order to access and copy the data from the target container. The security host binary executable application can execute on that target container (e.g., within the target container itself) to copy data and other information from one or more folders in the container, such as folder/proc/1 in the target container. (See for example FIG. 6) The security host binary executable application can run as a root in order to collect the filesystem of the targeted container under “/proc.” The security host 106 invoked by the security engine 102 can create the security host binary executable application to run inside, not beside, the target container and can have an impact on the system as well as potentially more limited analysis. The security host binary executable application inspects a plurality of objects in the target container and then captures the plurality of objects from a memory and one or more instances of applications running on the target container. The security host binary executable application then sends the collected data from the target container over to a cloud storage location. Once the security host binary executable application captures the desired information and copies that information, then the collected information is sent from the target container over to a cloud storage location 110, such as an AWS S3 bucket. 3) In another method to conduct the investigation, when a third-party container provider policies and/or architecture force use of a security host binary executable application, and the target container being analyzed cannot have a security host binary executable application executing in that target container itself, then the security engine 102 will via a command line create an ephemeral sidecar container 108, such as an ephemeral debug container, to link up with the target container in a same pod in order for the ephemeral sidecar container 108 to host the security host binary executable application to capture information in the target container. (See for example FIG. 7) The security engine 102 via a command line command in the API can create the ephemeral sidecar container 108 (e.g., debug container) to run as a “sidecar” without impact on the target container.

Next, the security host binary executable application executing in a shell of an ephemeral sidecar container 108 also enables gathering detailed data from private clusters (e.g., a collection of nodes in a container environment) and distroless containers. Note, that private clusters and distroless containers are notoriously difficult to acquire data from and otherwise inspect, due to the security and network constraints when accessing them. When the third-party container provider policies and/or architecture allow the target container to host the security host binary executable application, but it is preferred to not compromise the integrity of the container itself, then the security engine 102 can also create the ephemeral sidecar container 108 through the command line to host the security host binary executable application. In an embodiment, the security host 106 can also create the ephemeral sidecar container 108 through the command line to host the security host binary executable application. A first command can create the ephemeral sidecar container 108 (e.g., a debug container), and a second command can invoke the security host 106.

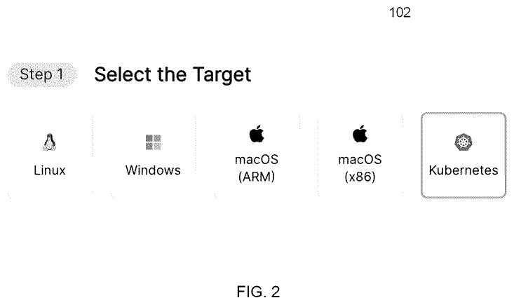

Again, in an embodiment, the security engine 102 and the security host 106 cooperate to support the collection of data from the private clusters and distroless containers. In an example, the user interface of the security engine 102 allows a user to navigate to ‘Import’ data collection through the security host 106. The user interface of the security engine 102 allows a user to select an example container platform, such as selecting ‘Kubernetes,’ and then follow the prompts to acquire data collection in the private cluster and/or distroless container. The user using the user interface can select the target system for data acquisition. For example, the categories of operating system utilized by computing systems supporting the container platform with the target container can include Linux based machines, Windows based machines, Mac OS X86 machines, Kubernetes, Mac ARM, etcetera, as shown in FIG. 2. FIG. 2 illustrates a diagram of an embodiment of a user interface that directs a security host to create and download a version of a security host binary executable application based upon a category of operating system utilized by a computing system supporting the container platform with the target container.

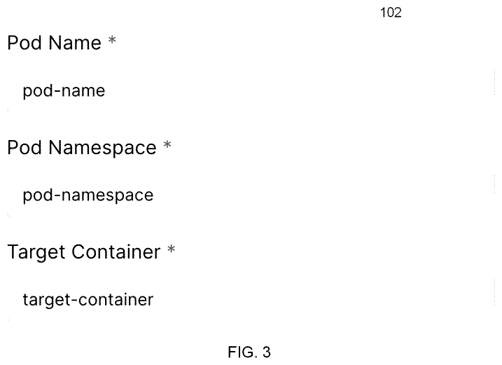

The user interface of the security engine 102 prompts the user to then enter the Pod Name, the Pod Namespace, and the Target Container. For example, the user interface of the security engine 102 can display as shown in FIG. 3. FIG. 3 illustrates a diagram of an embodiment of a user interface that allows a user to create a sidecar container that shares a same namespace and resource space with the target container.

The user interface of the security engine 102 cooperates with a data acquisition system in the security engine 102 to then generate a command for the container platform, such as Kubernetes, via its API, with a command such as kubectl. The security engine 102 generates a command through the Kubernetes API to create the ephemeral debug container that is attached to the container that the user wishes to acquire, and shares the same namespace and resources with the target container as follows:
kubectl debug-it pod-name—image=Debian: latest—target=target-container-n pod-namespace—sh-c. kubectl debug provides automation for common debugging tasks for cluster objects identified by resource and name. Pods will be used by default if no resource is specified.

As discussed, the security engine 102 accesses the Kubernetes API on the cluster to execute one or more commands, such as a command to create a debug container in a same pod as the target container. However, if a user cannot deploy a debug container, image “Debian: latest, due to any of policies, network access, or an admission controller, then the security engine 102 can create another substitute container image that has a shell, to deploy the security host binary executable application in. The substitute container must either have curl pre-installed, or the ability to install a curl. The security host binary executable application can run as a root in order to collect the filesystem of the targeted container under “/proc.

Thus, this command uses a Debian base image (e.g., a pre-built image that provides a foundation for building other, more specialized container images), which can potentially be changed as indicated below. The commands that are executed inside the debug container can include, for example:
first download the security host binary executable application;
apt-get update && apt-get-yy install curl procps;
mkdir-p/tmp/cado-host-b9ff9eebcurl-s;
https://cado-public.s3-accelerate.amazonaws.com/cado-host/v1.5.5/linux/cado-host—output/tmp/cado-host-b9ff9eeb/cado-host.

These commands can potentially be changed when they are not compatible with a particular infrastructure.

As discussed, the security engine 102 can use another method to generate a sidecar container, via a command line API, in order to support accessing the data from the target container. The sidecar container can be constructed as an ephemeral container that shares a same namespace and resource space with the target container with commands and/or steps that satisfy 1) the third party container platform's policies and 2) the third party container platform architecture's limitations or settings, in order to access and copy the data from the target container. The security engine 102 creates an ephemeral sidecar container 108 in a same pod as the target container to house a security host binary executable application in order to not compromise the integrity of the application in a target container while simultaneously cooperating with the security host binary executable application to investigate the target container for malicious activities.

Again, when the security engine 102 cannot deploy the sidecar container 108 (e.g., default debug container image) due to policies, network access, or an admission controller, then the user interface of the security engine 102 can substitute any sidecar container 108 image for an image of the user's choice. An alternative sidecar container 108 to the default debug container should have a shell to deploy the security host binary executable application in. The sidecar container 108 either has a curl pre-installed, or the ability to install it in the field. In an embodiment, the container will always have curl installed.

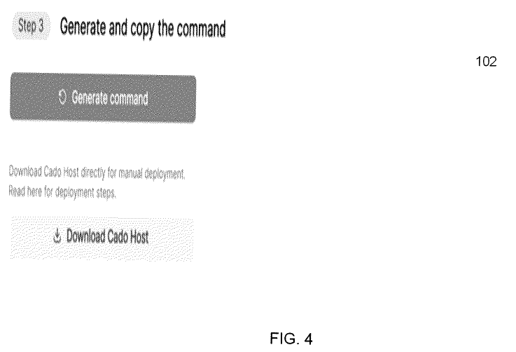

In a next step, the user interface of the security engine 102 prompts the user to copy a command to invoke the security host 106 hosted on a Uniform Resource Locator (URL). (See FIG. 4). FIG. 4 illustrates a diagram of a user interface that allows a user to generate commands and download a version of a security host binary executable application.

The user interface of the security engine 102 also prompts the user to then generate the command to download the security host binary executable application. The security host 106 is executed/invoked with the pre-signed URL (Uniform Resource Locator) generated by the security engine 102 to create an instance of the security host binary executable application to collect the desired data. The security host 106 can execute a shell script to download the security host binary executable application to run in a Kubernetes container. The security host 106 can utilize root access to access the underlying container file system (usually under/proc/{PID} /root). The user interface of the security engine 102 prompts the user to run this security host binary executable application on their container system with access to its control plane, for example, the Kubernetes cluster's control plane, using the Kubernetes API of the cluster that the user wants the security host binary executable application to acquire data from. Depending on the implementation, the user interface of the security engine 102 prompts the user to run the security host binary executable application i) within the target container or ii) create a sidecar container 108 to link with the target container in a same pod as the target container.

The security host binary executable application will execute and run to acquire data from the target container and then send that collected information into a specified cloud storage location. The files of the target container are collected from under, for example, the folder “/proc/1/”. The proc file system also provides a communication medium between the kernel and user space. Note, the security host binary executable application can cooperate with the kernel. The kernel is the core program on which all the other operating system components rely, it is used to access the hardware components and schedule which processes have to run on a computer system and when, and the kernel also manages the application software and hardware interaction.

Note, a sidecar container 108 can be an ephemeral container that differs from other containers in that they lack guarantees for resources or execution, and they will at no time be automatically restarted, so they are not appropriate for building applications. However, this ephemeral container is useful for interactive troubleshooting and the security host binary executable application can acquire data from the target container by utilizing its capabilities.

Also, distroless images enable the deployment of minimal container images that reduce the attack surface and exposure to bugs and vulnerabilities. Since distroless images do not include a shell or any debugging utilities, it was difficult to troubleshoot distroless images using kubectl alone. The debug container can be attached to the target container that the user wishes to acquire data from. The target container can be a distroless container in the third party container platform, a non-distroless container with a private cluster of nodes that utilize internal IP addresses for all of the nodes, which means the private cluster of nodes is isolated from access from a public Internet in the third party container platform, or something similar.

Next, as discussed, the security host binary executable application can i) run directly within the target container or ii) run in the shell of a sidecar container 108 attached to the target container that shares namespace and resources with the target container in the same pod in order to obtain the information and logs from the target container. The collected information is then sent from the security host binary executable application to a cloud storage location 110, such as an S3 bucket, and then periodically securely pulled to gather the collected information back to the security engine 102 for security analysis of that information.

As discussed, the security host binary executable application runs in the container and/or a sidecar container 108 and then collects interesting files. In an embodiment, the security host binary executable application can acquire the data from the potentially compromised target container in a manner that maintains a full chain of custody for forensic investigations. For example, the data can include a log capturing of information such as which hosts accessed the target container and then a time stamp, and other captured metadata such as each host that accessed the target container, etc. to verify the veracity of the captured information. (See for example FIG. 6) The security host binary executable application can gather as much data as possible (e.g., a large set of data including binary files as well as logs for the container and its virtual system) at a snapshot in time. The security host binary executable application gathers a much greater level of data for later analysis combined with often occasional data snapshot updates. The security host binary executable application can also generate a hash of the acquired data and store that hash. The security host binary executable application can compress the data collected from the potentially compromised container as the data is uploaded to the cloud storage and perform a cryptographic hash of the copied disk to create a chain of custody that ensures the disk image is a true copy of the original disk. The security host binary executable application then forensically packages the collected information and uploads that information to cloud storage such as an S3 bucket.

Thus, the security host binary executable application runs in the Kubernetes container to collect data from the Kubernetes container including forensic artifacts and other information, and then uploads the collected files to cloud storage, which is then forwarded to the security engine 102 for processing. The security host binary executable application copies data and metadata associated with the target container and forwards that information to cloud storage, and then the security engine 102 obtains that copy of the information and performs multiple kinds of analysis on that information.

Next, the security engine 102 running on the backend server has components configured to analyze the information from the target container to figure out if something is bad, or if something is not bad, or if something is unusual. The security engine 102 and the security host 106 cooperate to perform security detections and investigations in a wide range of container platforms with variances in tenant policies and underlying architecture. The security engine is configured to be hosted on a scalable, cloud-based computing network with a backend server that includes a data acquisition system, a data analysis system, and an action recommendation system, which cooperates with a security host for performing forensic analysis of a container platform. Each of the data acquisition system, the data analysis system, and the action recommendation system can include one or more processors and memory storing executable code that, when executed by one or more processors, performs the functionality described herein.

The security engine 102 uploads the plurality of objects of the target container from the cloud storage inspected by the security host binary executable application. The security engine 102 analyzes the plurality of objects, as a part of the electronic and digital investigation, for activities that cause a violation of a policy. The security engine 102 determines a violation of a policy of a tenancy of the target container. In response to analysis, the security engine 102 remediates a threat from the violation of the policy depending upon the policies of the tenancy of the target container. The security engine 102 has an input output circuit in the data acquisition system to support the acquisition of data from the cloud storage location 110. The private bucket and/or web server functioning as the cloud storage location 110 can be a remote space for the storage of data in the cloud that can be evidence for the incident. The security engine 102 106 analyzes disk images or zip files uploaded to the cloud storage location 110 as part of an investigation. An incident is any event where an unauthorized unit makes content with the target container, and data of the target container is compromised.

Next, the security engine 102 on the cloud computing network has components configured to analyze the information from the target container. The data acquisition system of the security engine 102 unpacks that data, including logs from various operating systems, binary files, an image of a disk drive, etc. while maintaining its forensic nature. The data is often packaged in a zip like compressed file format when copied from the target container. The data acquisition system passes the received and unpacked information onto the data analysis system of the security engine 102. The data analysis system of the security engine 102 attempts to recognize and understand the different types of data retrieved and processes different types of file formats, potentially hundreds of file formats. The data analysis system of the security engine 102 then normalizes the unpacked data into a standard measure and format and then passes it on to the next stages of analysis. The security engine 102 is configured to have a data analysis system with a processing pipeline to analyze the normalized data from the target container as a part of the investigation to detect for one or more of i) a violation of a policy and ii) malicious activity, associated with the target container. A comparison can occur on, for example, binary encoded files that record the history of that system potentially going back to when it was first installed or even created by Microsoft, etc. The data analysis system of the security engine 102 can then perform some Al analyses and detections on the data. The data analysis system of the security engine 102 can use a set of detections against logs and work out what is unusual or malicious in the logs. The data analysis system of the security engine 102 can use a set of detections against binary files to look at and determine what is malicious and/or unusual in terms of those binary files, which could be malware, or personally identifiable information left associated with a password of a user, or a cyber attacker left a backdoor password, etc. The data analysis system of the security engine 102 can process millions of events per snapshot of captured data and so now the user interface of the security engine 102 determines what information to surface to present directly to the user and what data to merely store but allow the user to drill down to look at. The data is organized and centralized to assist the user in presenting that information back to the user.

The action recommendation engine of the security engine 102 can suggest one or more remediation actions based upon the analyzed data from the target container. A user interface of the security engine 102 can convey the analyzed data from the target container and the suggested remediation actions to a security team in at least one of I) on a display device and II) in a report. The suggested actions can include isolating the host connected to the computer system, installing an anti-virus, disconnecting the computer system, and/or other remediations in response to the risks. The suggested actions may be determined based on a preset set of rules or machine learning algorithms or predefined by the user. The suggested actions are displayed to the user on the display device. The set of suggested actions includes executing a wizard, evaluating an enrichment to one or more log events, or managing an action using an auto-suggest technique.

Next, in an embodiment, the security engine 102 can configure a cluster role-based access control to acquire artifacts from the target container. The security engine 102 can enable for each cluster the following Kubernetes permissions: pods-get, list; and pods/exec-create, get.

The security engine 102 can add the following cluster role and cluster role binding to the cluster's RBAC configuration with the permissions listed.
apiVersion: rbac.authorization.k8s.io/v1
kind: ClusterRole
metadata:
   name: cado-eks-cluster-role
rules:
   apiGroups: [“”]
   resources: [“pods”]
   verbs: [“get”, “list”]
   apiGroups: [“”]
   resources: [“pods/exec”]
   verbs: [“create”, “get”]
apiVersion: rbac.authorization.k8s.io/v1
kind: ClusterRoleBinding
metadata:
   name: cado-eks-cluster-role-binding
subjects:
   kind: Group
   name: cado
   apiGroup: rbac.authorization.k8s.io
roleRef:
   kind: ClusterRole
   name: cado-eks-cluster-role
   apiGroup: rbac.authorization.k8s.io

In an embodiment, the security engine 102 and the security host 106 cooperate to collect data by acquiring the volume of the node as follows. When executing code inside the container or connecting over the network is not possible, you can acquire the volume of the node running the container. For example, this approach works for EKS running on EC2 nodes.
If using the Docker container runtime, container file systems are usually available at/var/lib/docker/overlay2.
If using the container runtime (which is now the default for EKS), the container file system is not immediately visible. The security engine 102 cooperating with the security host 106 supports container-based volume acquisitions.

In an embodiment, the security engine 102 and the security host 106 cooperate to collect data by using the security host 106 with a sidecar container 108 as discussed previously and as follows. The security host 106 supports collecting from private clusters and distroless containers by using a debug container. To acquire data, follow the steps in the user interface described above.

In an embodiment, the security engine 102 and the security host 106 cooperate to use a custom image. In environments where the default Debian: latest image is not supported; the user interface guides the user on how to use a custom image. The custom image can use the latest version of Linux based security host 106 located at a URL such as/tmp/cado-host-static/cado-host.

In an embodiment, the security engine 102 and the security host 106 cooperate to collect data from private clusters with no network access. The security engine 102 and the security host 106 cooperate to collect data from private clusters private AKS clusters using the normal user interface, and Azure's “command invoke” feature for private clusters. The security engine 102 and the security host 106 cooperate to collect data from Private GKE Clusters through public endpoints on private clusters. The security engine 102 and the security host 106 cooperate to collect data from private EKS clusters using a method like VPC peering or another connection option to access the API.

Thus, the security engine 102, the security host 106, and the security host binary executable application 106 can use the components and methods discussed above to cooperate to perform a forensic investigation with the electronic and digital investigation method for the target container and private clusters of nodes (e.g. worker machines) in the target container that do not have an external IP address as well as on a distroless container.

FIG. 5 illustrates a flowchart of the electronic and digital forensic investigation of the target container 308 by the security engine 102. An example process is discussed for the security engine to invoke the security host to create an instance of the security host binary executable application to collect information and or run in an ephemeral side container linked to the target container. The security engine directs an electronic and digital investigation of a target container (including private clusters of nodes in a container and distroless containers.

The security engine 102 can use a cloud network to scale up and down in virtual machines to perform tasks to cause fewer computing resources to be used for processing the tasks (e.g., due to the workers automatically terminating after the tasks are all processed) and the tasks are processed faster (e.g., due to the tasks being processed by workers in parallel and scaled to match the processing load associated with the set of tasks). After the tasks below have been processed, the unneeded nodes and components are automatically terminated, thus freeing up compute resources.

At block 402, the security engine 102 generates a command for the Kubernetes API. Using the Kubernetes API, Kubectl is a command tool for communicating with a Kubernetes cluster's control plane, using the Kubernetes API. The command runs through the cluster access platform 104, a system with access to the Kubernetes cluster's control plane.

In an embodiment, the cluster access platform 104 can be a bastion host which allows the user to connect a private network from an external network and act as clusters. The bastion host can be a special-purpose computer that acts as a secure gateway, controlling access to a private network from an external network. The bastion host sits on the edge of a network, between the public internet and a private network, acting as the only point of entry for external access. The bastion host logs all access attempts and sessions, providing valuable information for security auditing and incident response. The security engine 102 entails both writing and executing access to containers to download and execute the security host binary to collect forensic artifacts from side containers. In particular, security engine 102 entails ‘get’ and ‘list’ for the pods' resource, and ‘get’ and ‘create’ for the ‘pods/exec’ resource. The security host 106 can run as a normal user.

At block 404, the command from the security engine creates a debug container, which is an ephemeral container sharing the namespace and resources of the target container (i.e., the container) 308. This allows the security engine 102 to view the processes of the target container without compromising the integrity of the application 316 and/or the entire attack surface of the container.

At block 406, the security host binary executable application is downloaded in the debug container 108. In an embodiment, if the user is using an agent in the target container that has the ability to execute code, then the user may be able to collect data by manually deploying the security host 106 inside the target container for collection. The data collected is enriched using third-party and proprietary threat intelligence. Important incident details such as root cause, compromised roles and assets, and a complete timeline of events are automatically surfaced. With the security engine 102, analysts of all levels can perform complex investigations.

At block 408, the security host binary executable application processes, runs, and collects interesting files from the filesystem and then uploads the result to the cloud storage location 110 such as a private bucket using a pre-assigned URL. The security host binary executable application is downloaded and run by the debug container 108. The data is zipped and uploaded to the cloud storage location 110. The data is then processed by the security engine 102.

At block 410, the security engine 102 determines if the container activity violates a policy predefined in the tenancy to which application 316 belongs.

At block 412, if no policy is violated, the security host 106 captures data of the target container. This includes the data from the resources and the memory of the target container. The data is stored in a cloud storage location 110 such as a private bucket to be analyzed later as it can provide information for forensic analysis in the future.

At block 414, if the policy is violated, the event is categorized as an incident, and the data is analyzed for damage mitigation. For example, if the component has been compromised by malicious activity (e.g. an attacker) or policy violation, then the component is compromised, and then automatically isolated to prevent further damage. The container oriented and serverless resources are ephemeral by nature. They enable immediate threat detection, as evidence vanishes quickly. The security host 106 dynamically investigates the distroless container 308 in time using dynamic resources like EKS, AKS, GKE, and Kubernetes. The security engine 102 and the security host 106 cooperate to provide investigations in distroless containers. The security engine 102 and the security host 106 cooperate to support investigations in distroless container environments and then provide that information to eliminate critical blind spots and deliver unprecedented visibility into cloud risk. In an embodiment, a security engine facilitates an electronic and digital investigation of distroless and non-distroless containers without compromising their integrity. The security engine 102 and the security host 106 cooperate to provide automated forensic investigation and response in distroless container environments. The security engine 102 and the security host 106 cooperate to investigate the root cause, scope, and impact of malicious activity detected within distroless container environments to gain greater visibility into cloud risk and provide this information through a user interface to a security team. In general, distroless containers are designed for efficiency and security, stripped of standard OS components like shell utilities and package managers. While these distroless containers offer some security benefits by minimizing the attack surface, they actually leave a huge security blind spot when something malicious does indeed occur. In general, it was nearly impossible to perform an investigation in these environments, resulting in a significant visibility security gap. The security engine 102 and the security host 106 cooperate to collect data from distroless containers and private clusters without impacting the target container to enable immediate investigation. The collected data can include individual running processes, crucial log files, and other forensic artifacts for forensic analysis. This evidence is then seamlessly presented in the security engine platform for unprecedented visibility into cloud risk.

At block 416, the security engine 102 begins incident remediation. The remediation steps for the target container are also dictated by the policy of its corresponding tenancy. Automated remediation actions can be defined based on detection severity. The security engine 102 rapidly contains the threat and prevents further damage and spread of threats. The security engine 102 also has automated remediation responses to security incidents without human intervention.

Again, the security engine 102 and the security host 106 cooperate to provide automated investigation and incident response for the cloud network. The security engine 102 and the security host 106 cooperate to significantly reduce response times by automating the capture, processing, and analysis of data residing in the cloud (e.g., container, serverless, SaaS), and on-premises environments. The security engine 102 and the security host 106 cooperate to provide a user interface as well as notifications and reports to empower security teams to review and see critical context to a security investigation on most system. The security engine 102 and the security host 106 cooperate to provide security analysis of a scalable, cloud-based, computer architecture by performing forensic analysis of components in scalable, cloud-based, computer architecture to identify when the computer architecture has been compromised by a malicious threat.

FIG. 6 illustrates a block diagram of an embodiment of the security host binary executable application getting information from the target container and the files gathered.

A ‘path/proc/1/root/app’ of directory 202 shows that this is a root filesystem, an init system in a Linux environment. Init system is the first process started during a system boot. A daemon process continues running until the system is shut down. Init is the direct or indirect ancestor of all other processes and automatically adopts all orphaned processes.

“.git” is a hidden folder used by Git to store repository data. A Git repository tracks and saves the history of all changes made to the files within a Git project. The repository maintains a chronological record of individual modification, allowing the user to revisit previous versions of the user project.

“cado-eks-cluster-role-binding.yml” a Yet Another Markup Language (YAML) file containing AWS elastic Kubernetes service (EKS) cluster role binding configurations. YAML is a human-readable data serialization language commonly used for various purposes, including writing configuration files, data exchange between different applications or services, and storing metadata. EKS cluster role binding configurations ensure that EKS has the imperative permissions to manage resources within the user Kubernetes clusters, making cluster management more efficient and secure. Amazon EKS uses service-linked roles, which are unique identity and access management (IAM) roles linked to EKS. These roles are predefined by Amazon EKS and include all the permissions that are imperative for EKS to interact with other AWS services on the user's behalf. Service-linked roles simplify setup because the user does not have to manually add permissions; EKS defines and manages them. Permissions include network interfaces, security groups, logs, and VPC (virtual private cloud) management.

“create-cluster.sh” Despite the ‘.sh’ extension, it's listed as YAML; it's a script for creating a cluster.

“deployment-manifest.yml” contains deployment specifications for Kubernetes. A deployment defines attributes such as the number of replicas of the application that has to be running and a desired image to use (usually a container image). The attribute also includes configuration parameters related to the application.

A Docker file is a text document containing all the commands to assemble an image. The Docker file serves as a blueprint for creating Docker images. The Docker file defines the steps for building an image, including installing dependencies, configuring settings, and setting up the environment. Some of the instructions in a Docker file are as follows:

FROM: Specifies the base image to build upon.

RUN: Executes commands during image build (e.g., installing packages).

COPY and ADD: Copy files from the host into the image.

ENV: Sets environment variables.

EXPOSE: Describes which ports the application listens on.

CMD and ENTRYPOINT: Define default commands or executables when the container starts.

WORKDIR: Sets the working directory inside the container.

“README.md” is a markdown file used for documentation containing instructions or information about the software. Markdown is a markup language, designed to be readable even in its raw form, without rendering.

“service.yaml” contains service definitions for Kubernetes. In Kubernetes, a Service is an abstraction that defines a logical set of Pods and a policy by which to access them. A Pod can be the smallest ephemeral deployable unit of computing, which contains a group of one or more containers that share storage, a network namespace, and other resources. Services enable network exposure for one or more Pods within a cluster, allowing for stable communication regardless of changes in Pod instances. There are several types of Services, including ClusterIP (internal), NodePort (external on a port), Load Balancer (external with a load balancer), and External Name (maps to a DNS name) Services are used to provide a consistent endpoint for Pods, handling load balancing and ensuring that clients can interact with the set of Pods as if they were a single entity1. Typically, the set of Pods a Service targets is determined by a selector defined in the Service's configuration.

“test-py.yaml” concerns Python applications or scripts.

FIG. 7 illustrates a block diagram of an embodiment of the security engine creating an ephemeral sidecar container to link with the target container so that the ephemeral debug container can host the security host binary executable application to collect the information and files from the target distroless container sharing a pod, in order to provide a mechanism to obtain the information in these containers and then send that information over to the storage bucket.

Referring to FIG. 7, illustrating a block diagram of a Kubernetes cluster 300 with the debug container 108 and a distroless or non-distroless container 308 sharing a container pod 306. The Kubernetes cluster 300 includes a master node 302, which includes etcd 320, a controller-manager 322, and a scheduler 324. The Kubernetes cluster 300 includes a worker node(s) 304 that includes the container pod 306, the debug container 108, the distroless container 308, an application 316, a resource dependency 318, kubelet 312, and a proxy 314. A Kubernetes cluster consists of a set of worker machines, called nodes, that run containerized applications. Every cluster has a minimum of one worker node.

The worker node(s) 304 hosts the container pods 306 which are the components of the application workload. The container pod 306 is the petite deployable unit of computing that the user can create and manage in Kubernetes. The container pod 306 is a group of one or more containers with shared storage and network resources and a specification for how to run the containers. A control plane manages the worker node(s) 304 and the container pod 306 in the cluster. In production environments, the control plane usually runs across multiple computers, and a cluster usually runs multiple nodes, providing fault-tolerance and high availability.

The etcd 320 is a consistent and universally available key-value store used as Kubernetes' backing store for all cluster data. The etcd 320 can be a distributed key-value store used to hold and manage the critical information that distributed systems need to keep running. Most notably, the etcd manages the configuration data, state data, and metadata. The etcd 320 is an open-source, distributed, consistent key-value store for shared configuration, service discovery, and scheduler coordination of distributed systems or clusters of machines. The etcd 320 helps to facilitate safer automatic updates, coordinates work being scheduled to hosts, and assists in the setup of overlay networking for containers.

The scheduler 324 is the control plane component that watches for a newly created container pod 306 with no assigned node and selects a node for them to run on. Factors taken into account for scheduling decisions include individual and collective resource requirements, hardware/software/policy constraints, affinity and anti-affinity specifications, data locality, inter-workload interference, and deadlines.

The Kubelet 312 is an agent that runs on an individual node in the cluster. The Kubelet 312 makes sure that containers are running in the container pod 306. The Kubelet is a “node agent” that can register the node with the apiserver using one of: the hostname; a flag to override the hostname; or specific logic for a cloud provider.

The Kubelet 312 takes a set of PodSpecs that are provided through various mechanisms and ensures that the containers described in those PodSpecs are running and healthy. The PodSpecs describes a version of a pod library. One pod, over the course of time, will have many Specs. It includes details about where the source has to be fetched from, what files to use, the build settings to apply, and other general metadata such as its name, version, and description. The Kubelet 312 does not manage containers that were not created by Kubernetes.

The proxy 314 is a network proxy that runs on an individual node in the cluster of the user, implementing part of the Kubernetes Service concept. The proxy 314 maintains network rules on nodes. These network rules allow network communication to the container pod 306 from network sessions inside or outside of the cluster. The proxy 314 uses the operating system packet filtering layer if there is one and it is available. Otherwise, proxy 314 forwards the traffic itself.

An individual node in a Kubernetes cluster runs the containers that form the container pod 306 assigned to that node. Containers in the container pod 306 are co-located and co-scheduled to run on the same node. A container image is a ready-to-run software package containing the whole imperative to run an application 316, the code, and any runtime it entails, application and system libraries, and default values for any elemental settings. The containers are intended to be stateless and immutable: the user cannot change the code of a container that is already running. If the user has a containerized application and wants to make changes, the correct process is to build a new image that includes the change and then recreate the container to start from the updated image.

The Docker images of the container 308 can be a stripped-down version of regular Docker images. In essence, the Docker images of the distroless container 308 contain the complete rudiments entailed to run the application 316. This means they lack operating system tools and shells. The Docker images of the distroless container 308 are not devoid of an OS, but they carry only the OS's minimal runtime components. The Docker image is a lightweight, standalone, executable package that encompasses all the necessities to run a piece of software, including the code, runtime, system tools, libraries, and settings. The Docker images are built from a Docker file, a script containing a series of instructions used to generate the image. The Docker images of the distroless container 308 contain the application binary, the application's direct dependencies (libraries, modules, etc.), system libraries, shell utilities, package managers and any other binaries or tools typical of an OS distribution.

When an application is containerized, it includes all the imperative components within the container image. These resource dependencies 318 include runtime environment, system tools and libraries, configuration settings, networking, storage volumes, host kernel, etc.

The debugging works by creating a new container in same container pod 306 as the application 316, called a debug container 108. The debug container 108 runs a debugging tool, such as GDB (Gnu Debugger) or strace, and attaches to the existing application container. This allows the debugging of the application 316 in real-time, without interrupting normal operation of the application 316.

With the growing popularity of Microservices, where large monolithic applications are broken down into smaller autonomous services, orchestration tools have become widespread. Docker helps to encapsulate these services into isolated runtime environments known as containers. A container in the cloud can be a portable and self-contained environment for running software applications in a cloud computing environment. The container packages an application and all its dependencies into a single unit, allowing the application to be deployed and run consistently across different computing environments. A container can be moved and run on different servers or even different cloud platforms with minimal modifications. An individual container is repeatable; the standardization from having dependencies included means the user gets the same behaviour wherever the user runs it. Containers decouple applications from the underlying host infrastructure. This makes deployment easier in different cloud or operating system (OS) environments. Containers can be easily scaled up or down based on demand, allowing for dynamic resource allocation. Platforms like Kubernetes offer container management solutions that control the containers these microservices run upon. Other container orchestration platforms include Mirantes Kubernetes Engine (formerly known as Docker Enterprise), Amazon Elastic Container Service (ECS), Google Kubernetes Engine (GKS), SaltStack, Rancher, Azure Kubernetes Services (AKS), Red Hat Open Shift Container Platform, etc. Kubernetes is an open-source Container Management tool that automates container deployment, container scaling, descaling, and container load balancing (also called a container orchestration tool).

Kubernetes offers horizontal scalability; a user can scale the application containers depending on the incoming traffic. Kubernetes has no downtime issues regarding the application. A user can achieve high availability for the application with the help of Kubernetes and it will reduce the latency issues for the users. Kubernetes is also cost-effective; if there is unnecessary use of infrastructure, the cost will also increase. Kubernetes will help the user to reduce resource utilization and control the over-provisioning of infrastructure.

The inflated use of the container orchestration tool also entails a security solution for a container that does not compromise the integrity of the application while simultaneously protecting the container from malicious entities. The malicious entities are usually hackers trying to break into the container to steal or manipulate data. Threat from the malicious entities is determined on the basis of attack surface. The attack surface of the container image is measured by the number of files in the container, how many megabytes of space the container uses on disk, and/or its footprint in memory while running. In an embodiment, the attack surface of the container image is measured by all three of the number of files in the container, how many megabytes of space the container uses on disk, and its footprint in memory while running. However, not every file contributes to the attack surface equally. Files that are directly in the execution path (web servers, C libraries, etc.) are more likely to expand the attack surface than files. A distroless container is utilized to evade this threat. The distroless containers address these topics with images that contain only the application, its resources, and language runtime dependencies, no operating system distribution. The image is a static, an immutable blueprint for creating containers, while a container is a running instance of that image, providing an isolated environment for running applications. The distroless containers create a smaller attack surface, reduce compliance scope, and result in a small performant container. A distroless container offer an approach to create minimal and secure container images by stripping away system components that are unnecessary at execution time, such as package managers and shells.

Since distroless images have no operating system, a multi-stage Docker build is used to perform some configuration work upfront and then selectively copy artifacts into the distroless image.

The security engine 102 can connect to the distroless image using the kubectl attach, kubectl exec, and kubectl logs commands. Docker build can be a command-line tool used in the docker ecosystem to build docker images from a Docker file. The Docker file is a text document that contains commands that a user could call on the command line to assemble an image. Using Docker build, the user can automate the process of creating docker images, which are lightweight, portable, and self-sufficient containers that package up an application and its dependencies.

### Computing Devices

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory storage devices in an executable format to be executed by one or more processors. The computer readable storage medium may be non-transitory and does not include radio or other carrier waves. The computer readable storage medium could be, for example, a physical computer readable storage medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit.

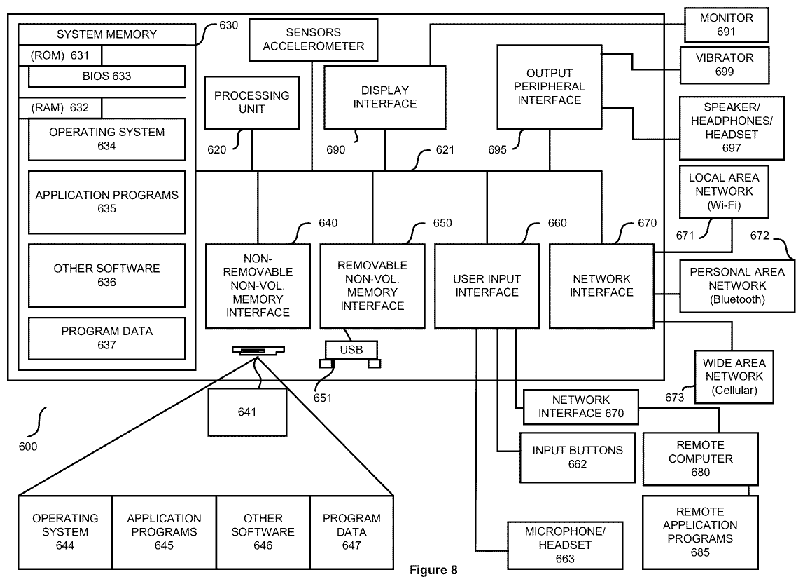

FIG. 8 illustrates a block diagram of an embodiment of one or more computing devices that can be a part of the security engine and other components discussed herein.

The computing device may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this design implemented in software 644, 645, 646 are stored in the one or more memories 630-632 and are executed by the one or more processors 620. The processing unit 620 may have one or more processing cores, which couples to a system bus 621 that couples various system components including the system memory 630. The system bus 621 may be any of several types of bus structures selected from a memory bus, an interconnect fabric, a peripheral bus, and a local bus using any of a variety of bus architectures.

Computing device 602 typically includes a variety of computing machine-readable media. Machine-readable media can be any available media that can be accessed by computing device 602 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 602. Transitory media such as wireless channels are not included in the machine-readable media. Machine-readable media typically embody computer readable instructions, data structures, and other executable software. In an example, a volatile memory drive 641 is illustrated for storing portions of the operating system 644, application programs 645, other executable software 646, and program data 647.

A user may enter commands and information into the computing device 602 through input devices such as a keyboard, touchscreen, or software or hardware input buttons 662, a microphone 663, a pointing device and/or scrolling input component, such as a mouse, trackball, or touch pad 661. The microphone 663 can cooperate with speech recognition software. These and other input devices are often connected to the processing unit 620 through a user input interface 660 that is coupled to the system bus 621, but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 602 can operate in a networked environment using logical connections to one or more remote computers/client devices, such as a remote computing system 680. The remote computing system 680 can a personal computer, a mobile computing device, a server, a router, a network PC, a peer device, or other common network node, and typically includes many or all of the elements described above relative to the computing device 602. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 602 is connected to the LAN 671 through a network interface 670, which can be, for example, a Bluetooth® or Wi-Fi adapter. When used in a WAN networking environment (e.g., Internet), the computing device 602 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 602, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. An apparatus, comprising:
a security engine configured to access a container platform through an Application Programming Interface to send one or more commands into the container platform to support accessing and copying data from a target container,
where the security engine is configured to implement two or more methods to conduct an investigation that accesses and copies the data from the target container running in the container platform in with commands and/or steps that satisfy 1) a container platform's policies and 2) a container platform architecture's limitations or settings, in order to access and copy the data from the target container,
where the security engine is configured to be hosted on a cloud computing network, where the security engine is configured to have a data analysis system with a processing pipeline to analyze the data from the target container as a part of the investigation to detect for one or more of i) a violation of a policy and ii) malicious activity, associated with the target container,
an action recommendation engine of the security engine configured to suggest one or more remediation actions based upon the analyzed data from the target container,
a user interface of the security engine to convey the analyzed data from the target container and the suggested remediation actions to a user in at least one of I) on a display device and II) in a report, and
where instructions implemented in software for the security engine are configured to be stored in one or more non-transitory storage mediums to be executed by one or more processing units.

2. The apparatus of claim 1, where the security engine is configured to use a first method to access the container platform and create a disk image that includes the target container with commands and/or steps that satisfy 1) the container platform's policies and 2) the container platform architecture's limitations or settings, in order to access and copy the data from the target container.

3. The apparatus of claim 1, where the security engine is configured to use a first method to invoke a security host to create and send down a security host binary executable application to run in a first container and work with the target container with commands and/or steps that satisfy 1) the container platform's policies and 2) the container platform architecture's limitations or settings, in order to access and copy the data from the target container.

4. The apparatus of claim 3, where the security engine is configured to use the first method to run the security host binary executable application i) within the target container or ii) create a sidecar container to link with the target container in a same pod as the target container, with commands and/or steps that satisfy 1) the container platform's policies and 2) the container platform architecture's limitations or settings, in order to access and copy the data from the target container.

5. The apparatus of claim 1, where the security engine is configured to use a first method to generate a sidecar container, via a command line API, in order to support accessing the data from the target container, where the sidecar container is constructed as an ephemeral container that shares a same namespace and resource space with the target container with commands and/or steps that satisfy 1) the container platform's policies and 2) the container platform architecture's limitations or settings, in order to access and copy the data from the target container.

6. The apparatus of claim 1, where the target container is at least one of 1) a private cluster of nodes that utilize internal IP addresses for all of the nodes, which means the private cluster of nodes is isolated from access from a public Internet in the container platform and 2) a distroless container in the container platform.

7. The apparatus of claim 3, where the security host binary executable application is further configured to inspect a plurality of objects in the target container and then capture the plurality of objects from a memory and one or more instances of applications running on the target container and then send collected data from the target container, over to a cloud storage location.

8. The apparatus of claim 1, where the security engine is configured to invoke a security host that is hosted on one or more URLs, where the security host is configured to create and download a version of a security host binary executable application based upon a category of operating system utilized by a computing system supporting the container platform with the target container, where the security host binary executable application is further configured to run in a first container and work with the target container in order to access and copy the data from the target container in a form and format that preserves a forensic nature of the copied data to maintain a full chain of custody for a forensic investigation.

9. A machine readable medium configured to store instructions and data to be executed by one or more processors, where the instructions when executed cause one or more computing devices to perform steps as follows, comprising:
providing a security engine to access a container platform through an Application Programming Interface to send one or more commands into the container platform to support accessing and copying data from a target container,
providing the security engine to implement two or more methods to conduct a forensic investigation that accesses and copies the data from the target container running in the container platform in with commands and/or steps that satisfy 1) a container platform's policies and 2) a container platform architecture's limitations or settings, in order to access and copy the data from the target container,
providing the security engine to be hosted on a cloud computing network,
providing the security engine to have a data analysis system with a processing pipeline to analyze the data from the target container as a part of the forensic investigation to detect for one or more of i) a violation of a policy and ii) malicious activity, associated with the target container,
providing an action recommendation engine in the security engine to suggest one or more remediation actions based upon the analyzed data from the target container, and
providing a user interface of the security engine to convey the analyzed data from the target container and the suggested remediation actions to a user in at least one of I) on a display device and II) in a report.

10. The machine readable medium of claim 9 configured to store instructions and data to perform further steps as follows, comprising:
providing the security engine to use a first method to access the container platform and create a disk image that includes the target container with commands and/or steps that satisfy 1) the container platform's policies and 2) the container platform architecture's limitations or settings, in order to access and copy the data from the target container.

11. The machine readable medium of claim 9 configured to store instructions and data to perform further steps as follows, comprising:
providing the security engine to use a first method to invoke a security host to create and send down a security host binary executable application to run in a first container and work with the target container with commands and/or steps that satisfy 1) the container platform's policies and 2) the container platform architecture's limitations or settings, in order to access and copy the data from the target container.

13. The machine readable medium of claim 12 configured to store instructions and data to perform further steps as follows, comprising:
providing the security engine to use the first method to run the security host binary executable application i) within the target container or ii) create a sidecar container to link with the target container in a same pod as the target container, with commands and/or steps that satisfy 1) the container platform's policies and 2) the container platform architecture's limitations or settings, in order to access and copy the data from the target container.

14. The machine readable medium of claim 9 configured to store instructions and data to perform further steps as follows, comprising:
providing the security engine to use a first method to generate a sidecar container, via a command line API, in order to support accessing the data from the target container, where the sidecar container is constructed as an ephemeral container that shares a same namespace and resource space with the target container to satisfy 1) the container platform's policies and 2) the container platform architecture's limitations or settings, in order to access and copy the data from the target container.

15. The machine readable medium of claim 9 configured to store instructions and data to perform further steps as follows, comprising:
where the target container is at least one of 1) a private cluster of nodes that utilize internal IP addresses for all of the nodes, which means the private cluster of nodes is isolated from access from a public Internet in the container platform and 2) a distroless container in the container platform.

16. The machine readable medium of claim 12 configured to store instructions and data to perform further steps as follows, comprising:
providing the security host binary executable application to inspect a plurality of objects in the target container and then capture the plurality of objects from a memory and one or more instances of applications running on the target container, and then send collected data from the target container over to a cloud storage location.

17. The machine readable medium of claim 9 configured to store instructions and data to perform further steps as follows, comprising:
providing the security engine to invoke a security host, which is hosted on one or more URLs,
providing the security host to create and download a version of a security host binary executable application based upon a category of operating system utilized by a computing system supporting the container platform with the target container, and
providing the security host binary executable application to run in a first container and work with the target container in order to access and copy the data from the target container in a form and format that preserves a forensic nature of the copied data to maintain a full chain of custody for the forensic investigation.

18. A method for a security engine to conduct an investigation by performing operations, comprising:
accessing a container platform through an Application Programming Interface to send one or more commands into the container platform to support accessing and copying data from a target container,
implementing two or more methods to conduct the investigation that accesses and copies the data from the target container running in the container platform in with commands and/or steps that satisfy 1) a container platform's policies and 2) a container platform architecture's limitations or settings, in order to access and copy the data from the target container,
operating on a cloud computing network,
using a data analysis system with a processing pipeline to analyze the data from the target container as a part of the investigation to detect for one or more of i) a violation of a policy and ii) malicious activity, associated with the target container,
suggesting one or more remediation actions based upon the analyzed data from the target container, and
using a user interface of the security engine to convey the analyzed data from the target container and the suggested remediation actions to a user in at least one of I) on a display device and II) in a report.

19. The method of claim 18 to perform further operations, comprising:
using a first method to access the container platform and create a disk image that includes the target container with commands and/or steps that satisfy 1) the container platform's policies and 2) the container platform architecture's limitations or settings, in order to access and copy the data from the target container.

20. The method of claim 18 to perform further operations, comprising:
using a first method to invoke a security host to create and send down a security host binary executable application to run in a first container and work with the target container with commands and/or steps that satisfy 1) the container platform's policies and 2) the container platform architecture's limitations or settings, in order to access and copy the data from the target container.
